(19) United States
(12) Patent Application Publication
(10) Pub. No.: US 2025/0094767 A1
(43) Pub. Date: Mar. 20, 2025

(54) SYSTEMS AND METHODS FOR SCALABLE ANOMALY DETECTION FRAMEWORKS

(71) Applicant: Walmart Apollo, LLC, Bentonville, AR (US)

(72) Inventors: Akshit Sarpal, Santa Clara, CA (US); Qiwen Kang, Santa Clara, CA (US); Lijie Wan, Mountain View, CA (US)

(21) Appl. No.: 18/470,905

(22) Filed: Sep. 20, 2023

(51) Int. Cl. G06N 3/042; G06N 3/088

(52) U.S. Cl. CPC G06N 3/042; G06N 3/088

(57) ABSTRACT

Systems and methods of anomaly detection using an optimal reference value are disclosed. A plurality of source-specific anchor values are received and a plurality of model features are generated. A plurality of trained source-specific classification models, each associated with at least one of the plurality of source-specific anchor values and each configured to receive a subset of the plurality of model features, are implemented. Each of the plurality of trained source-specific classification models is configured to classify the associated at least one of the plurality of source-specific anchor values as one of anomalous or non-anomalous. A trained weighted classification model is implemented to generate an optimal anchor value. The optimal anchor value includes a weighted aggregation of each of the plurality of source-specific anchor values identified as non-anomalous. An optimal reference value is generated based on the optimal anchor value.

### TECHNICAL FIELD

This application relates generally to anomaly detection, and more particularly, to anomaly detection in distributed systems.

### BACKGROUND

Network platforms may include databases that execute a large volume of updates for specific elements of data structures stored in the database. Database updates (e.g., adding new data records, modifying existing records, etc.) may be initiated and/or provided by first-party systems (e.g., systems operated by the individual(s) or entity that controls or implements the network platform (e.g., first party updates)) and/or from third party systems (e.g., systems operated by individual(s) or entities provided access to the network platform (e.g., third party updates)). The incorporation of third party updates introduce data quality and control concerns.

Third party updates may, intentionally or unintentionally, alter one or more elements of a data structure to an anomalous value that impacts operation of the network platform. Some current systems utilize basic logic to select comparison values for determining when an updated value is anomalous. However, these systems are prone to selecting incorrect comparison values, produce both false positive and false negative identifications, do not provide up-to-date values, and are not capable of providing comparison values for newly added database updates.

### SUMMARY

In various embodiments, a system including a non-transitory memory and a processor communicatively coupled to the non-transitory memory is disclosed. The processor is configured to read a set of instructions to receive a plurality of source-specific anchor values, generate a plurality of model features, and implement a plurality of trained source-specific classification models each associated with at least one of the plurality of source-specific anchor values and each configured to receive a subset of the plurality of model features. Each of the plurality of trained source-specific classification models is configured to classify the associated at least one of the plurality of source-specific anchor values as one of anomalous or non-anomalous. The processor is further configured to implement a trained weighted classification model to generate an optimal anchor value and generate an optimal reference value based on the optimal anchor value. The optimal anchor value includes a weighted aggregation of each of the plurality of source-specific anchor values identified as non-anomalous.

In various embodiments, a computer-implemented method is disclosed. The method includes steps of receiving a plurality of source-specific anchor values, generating a plurality of model features, and implementing a plurality of trained source-specific classification models each associated with at least one of the plurality of source-specific anchor values and each configured to receive a subset of the plurality of model features. Each of the plurality of trained source-specific classification models is configured to classify the associated at least one of the plurality of source-specific anchor values as one of anomalous or non-anomalous. The method further includes a steps of implementing a trained weighted classification model to generate an optimal anchor value and generating an optimal reference value based on the optimal anchor value. The optimal anchor value includes a weighted aggregation of each of the plurality of source-specific anchor values identified as non-anomalous.

In various embodiments, a non-transitory computer readable medium having instructions stored thereon is disclosed. The instructions, when executed by at least one processor, cause at least one device to perform operations including receiving a plurality of source-specific anchor values, generating a plurality of model features, and implementing a plurality of trained source-specific classification models each associated with at least one of the plurality of source-specific anchor values and each configured to receive a subset of the plurality of model features. Each of the plurality of trained source-specific classification models is configured to classify the associated at least one of the plurality of source-specific anchor values as one of anomalous or non-anomalous. The device is further configured to perform operations including implementing a trained weighted classification model to generate an optimal anchor value and generating an optimal reference value based on the optimal anchor value. The optimal anchor value includes a weighted aggregation of each of the plurality of source-specific anchor values identified as non-anomalous.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide anomaly detection, in accordance with some embodiments;

FIG. 2 illustrates a computer system configured to implement one or more processes, in accordance with some embodiments;

FIG. 3 illustrates an artificial neural network, in accordance with some embodiments;

FIG. 4 illustrates a tree-based artificial neural network, in accordance with some embodiments;

FIG. 5 illustrates a deep neural network (DNN), in accordance with some embodiments;

FIG. 6 is a flowchart illustrating an anomaly detection method, in accordance with some embodiments;

FIG. 7 is a process flow illustrating various steps of the anomaly detection method of FIG. 6, in accordance with some embodiments;

FIG. 8 is a flowchart illustrating an optimal reference value generation process, in accordance with some embodiments;

FIG. 9 is a process flow illustrating various steps of the optimal reference value generation process of FIG. 8, in accordance with some embodiments;

FIG. 10 is a flowchart illustrating a training method for generating a trained machine learning model, in accordance with some embodiments; and

FIG. 11 is a process flow illustrating various steps of the training method of FIG. 10, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for detecting anomalous values using multiple, independent data sources. In various embodiments, the disclosed systems and methods provide a scalable anomaly detection framework configured to provide anomaly detection based on multiple, independent data sources. For example, in some embodiments, a scalable anomaly detection framework may be configured to detect anomalous values in third party updates within large and/or expanding network platforms. As another example, in some embodiments, a scalable anomaly detection framework may be configured to detect anomalous values in systems including a plurality of sensors each configured to monitor the same and/or similar phenomenon. It will be appreciated that the disclosed systems and methods may be configured for anomaly detection in any system incorporating multiple, independent data sources that monitor or estimate a common phenomenon.

Disclosed systems and methods utilize an ensemble of trained models to detect irregularities in one or more features (e.g., data values) of a database update. An optimized weighting scheme may be applied to develop a reliable, real-time bound value for the one or more features. In some embodiments, a set of anchor values for a feature is obtained based on a plurality of database records, anomalous values within the set of anchor values are identified, and non-anomalous values in the set of anchor values are used to generate an optimized anchor value for the corresponding data feature.

The disclosed systems and methods provide a scalable anomaly detection framework that may be configured for network environments including limited and/or low quality data. For example, decentralized network environments, such as an e-commerce network environment that allows for third party seller listings and/or fulfillment, may provide limited and/or lower quality data due to one or more decentralized database update processes, such as adding or updating an item to a catalog associated with the e-commerce network environment. The disclosed systems and methods provide anomaly detection for decentralized network environments that may have higher volumes of database updates, include unreliable updates and/or participants, and/or lack features utilized in first-party anomaly detection. As used herein, the term “decentralized network environment” refers to fully decentralized network environments, partially decentralized network environments, and/or hybrid network environments including both centralized and decentralized elements.

In some embodiments, the disclosed scalable anomaly detection framework provides a module and robust detection framework for identifying both individual anomalous updates and anomalous comparison (e.g., anchor) values. For example, the disclosed scalable anomaly detection framework may utilize separate detector models for individual comparison data sources (e.g., anchor value sources). By applying separate detector models, the disclosed scalable anomaly detection framework allows for new detector models to be deployed for new comparison data sources and can provide increased coverage of comparison data sources as compared to a consolidated single model.

In some embodiments, systems, and methods for anomaly detection includes one or more trained classification models. The trained classification models may include one or more models, such as trained tree-based models (e.g., random forest models, decision tree models, etc.). In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

In some embodiments, a trained function may include a neural network, a support vector machine, a decision tree, a Bayesian network, a clustering network, Qlearning, genetic algorithms and/or association rules, and/or any other suitable artificial intelligence architecture. In some embodiments, a neural network may be a deep neural network, a convolutional neural network, a convolutional deep neural network, etc. Furthermore, a neural network may be an adversarial network, a deep adversarial network, a generative adversarial network, etc.

In various embodiments, neural networks which are trained (e.g., configured or adapted) to generate anchor value classifications and/or optimal anchor values, are disclosed. A neural network trained to generate anchor value classifications may be referred to as a trained source-specific classification model. A neural network trained to generate optimal anchor values may be referred to as a trained weighted classification model. A trained classification model may be configured to receive a set of input data, such as a set of generated model features and/or a set of received individual anchor values.

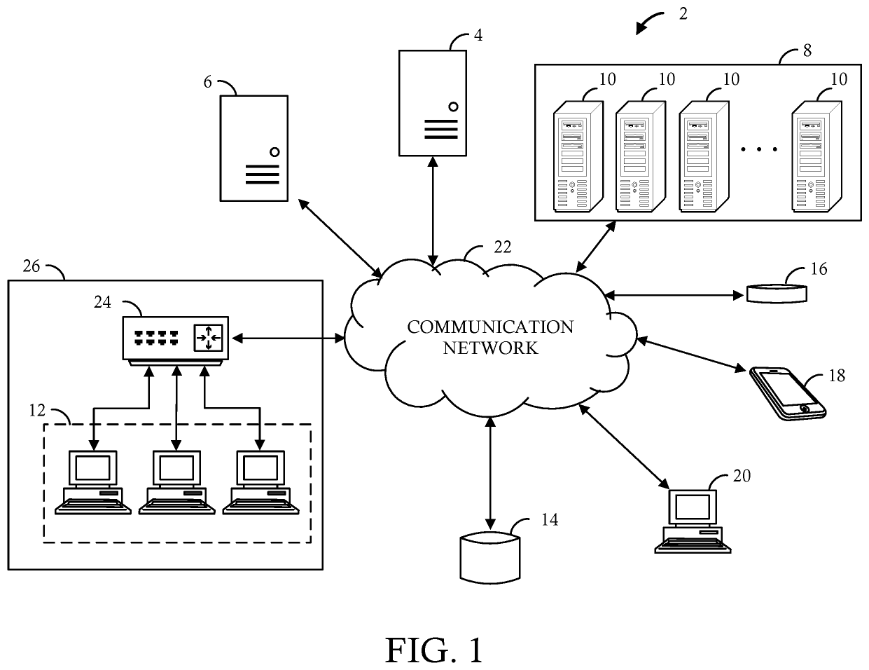

FIG. 1 illustrates a network environment 2 configured to provide anomaly detection, in accordance with some embodiments. The network environment 2 includes a plurality of devices or systems configured to communicate over one or more network channels, illustrated as a network cloud 22. For example, in various embodiments, the network environment 2 may include, but is not limited to, an anomaly detection computing device 4, a web server 6, a cloud-based engine 8 including one or more processing devices 10, workstation(s) 12, a database 14, and/or one or more third-party computing devices 16, 18, 20 operatively coupled over the network 22. The anomaly detection computing device 4, the web server 6, the processing device(s) 10, the workstation(s) 12, and/or the third-party computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the anomaly detection computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the anomaly detection computing device 4.

In some embodiments, each of the third-party computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the anomaly detection computing device 4, the processing devices 10, and/or the web server 6 are operated by the network environment provider, and the third-party computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the anomaly detection computing device 4, for example. The workstation(s) 12 may communicate with the anomaly detection computing device 4 over the communication network 22. The workstation(s) 12 may send data to, and receive data from, the anomaly detection computing device 4. For example, the workstation(s) 12 may transmit data related to tracked operations performed at the physical location 26 to anomaly detection computing device 4.

Although FIG. 1 illustrates three third-party computing devices 16, 18, 20, the network environment 2 may include any number of third-party computing devices 16, 18, 20. Similarly, the network environment 2 may include any number of the anomaly detection computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the anomaly detection computing device 4, the web server 6, the workstation(s) 12, the database 14, the third-party computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the first third-party computing device 16, the second third-party computing device 18, and the Nth third-party computing device 20 may communicate with the web server 6 over the communication network 22. For example, each of the third-party computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the third-party computing devices 16, 18, 20 to initiate a web browser that is directed to the website hosted by the web server 6. The user may, via the web browser, perform various operations such as implementing a database update to add and/or modify one or more items or offers maintained by a catalog associated with the e-commerce website. The website may capture these activities as user session data, and transmit the user session data to the anomaly detection computing device 4 over the communication network 22. The website may also allow the user to interact with one or more of interface elements to perform specific operations, such as uploading or modifying catalog entries. In some embodiments, the web server 6 transmits user interaction data identifying interactions between the user and the website to the anomaly detection computing device 4.

In some embodiments, the anomaly detection computing device 4 may execute one or more models, processes, or algorithms, such as a machine learning model, deep learning model, statistical model, etc., to identify anomalous feature values. In some embodiments, a user submits a database updated to the website hosted by the web server 6. The web server 6 may send a database update request to the anomaly detection computing device 4. In response to receiving the database update request, the anomaly detection computing device 4 may execute one or more processes to determine if one or more feature values of the database update request are anomalous and transmit the results including an approval and/or rejection of the database update request to the web server 6 to be displayed to the user.

The anomaly detection computing device 4 is further operable to communicate with the database 14 over the communication network 22. For example, the anomaly detection computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the anomaly detection computing device 4, in some embodiments, the database 14 may be a local storage device, such as a hard drive, a non-volatile memory, or a USB stick. The anomaly detection computing device 4 may store interaction data received from the web server 6 in the database 14. The anomaly detection computing device 4 may also receive from the web server 6 session data identifying events associated with third-party sessions, and may store the session data in the database 14.

In some embodiments, the anomaly detection computing device 4 generates training data for a plurality of models (e.g., machine learning models, deep learning models, statistical models, algorithms, etc.) based on received feature values and/or anchor values. The anomaly detection computing device 4 and/or one or more of the processing devices 10 may train one or more models based on corresponding training data. The anomaly detection computing device 4 may store the models in a database, such as in the database 14 (e.g., a cloud storage database).

The models, when executed by the anomaly detection computing device 4, allow the anomaly detection computing device 4 to identify anomalous anchor values and/or generate an optimal anchor value. For example, the anomaly detection computing device 4 may obtain one or more models from the database 14. The anomaly detection computing device 4 may then receive, in real-time from the web server 6, a database update request. In response to receiving the database update request, the anomaly detection computing device 4 may execute one or more models as part of an anomaly detection method, as discussed in greater detail below.

In some embodiments, the anomaly detection computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, anomaly detection computing device 4 may generate an optimal reference value for comparison to one or more feature values.

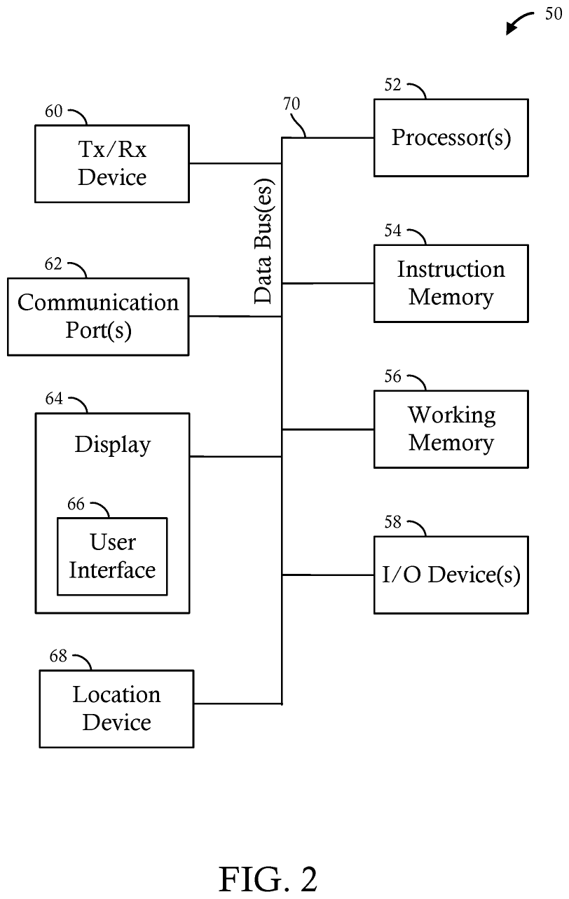

FIG. 2 illustrates a block diagram of a computing device 50, in accordance with some embodiments. In some embodiments, each of the anomaly detection computing device 4, the web server 6, the one or more processing devices 10, the workstation(s) 12, and/or the third-party computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™. Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for anomaly detection, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with a network catalog. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

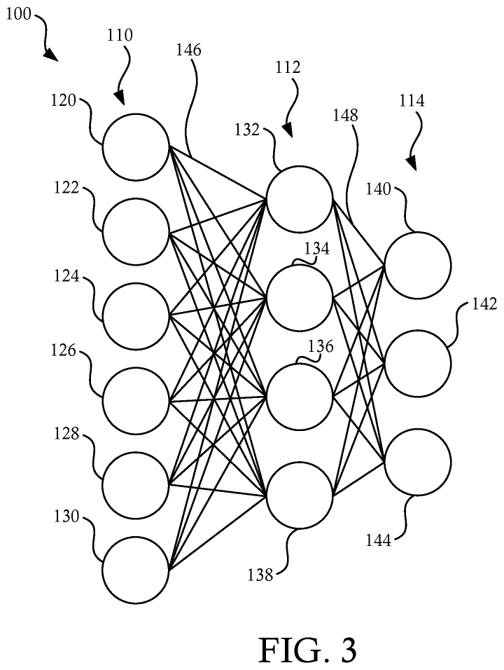

FIG. 3 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 120-138 of the m-th layer 110, 112 and the 2) j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f is the first derivative of the activation function, and γⱼ⁽ⁿ⁺¹⁾ is the comparison training value for the j-th node of the output layer 114.

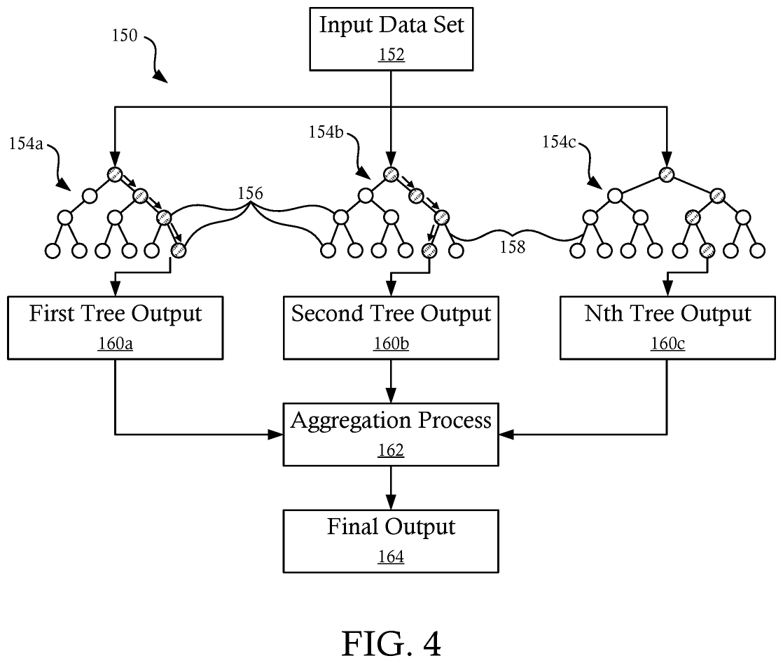

FIG. 4 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c may include a classification and/or a regression tree (CART). Classification trees include a tree model in which a target variable may take a discrete set of values, e.g., may be classified as one of a set of values. In classification trees, each leaf 156 represents class labels and each of the branches 158 represents conjunctions of features that connect the class labels. Regression trees include a tree model in which the target variable may take continuous values (e.g., a real number value).

In operation, an input data set 152 including one or more features or attributes is received. A subset of the input data set 152 is provided to each of the trained decision trees 154a-154c. The subset may include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 may apply a majority-voting process to identify a classification selected by the majority of the trained decision trees 154a-154c. As another example, in embodiments including regression trees, the tree-based neural network 150 may apply an average, mean, and/or other mathematical process to generate a composite output of the trained decision trees. The final output 164 is provided as an output of the tree-based neural network 150.

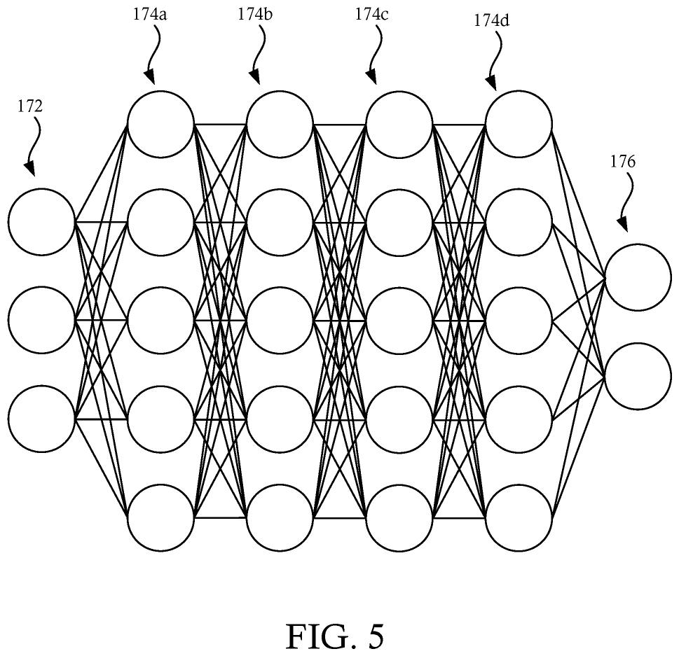

FIG. 5 illustrates a deep neural network (DNN) 170, in accordance with some embodiments. The DNN 170 is an artificial neural network, such as the neural network 100 illustrated in conjunction with FIG. 3, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where α^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 170 may include a neural multiplicative model (NMM), including a multiplicative form for the NAM mode using a log transformation of the dependent variable γ and the independent variable x:

$$y = {e}^{β} {e}^{f ( logx )} {e}^{{Σ}_{i} {f}_{i}^{d} ( {d}_{i} )}$$

where d represents one or more features of the independent variable x.

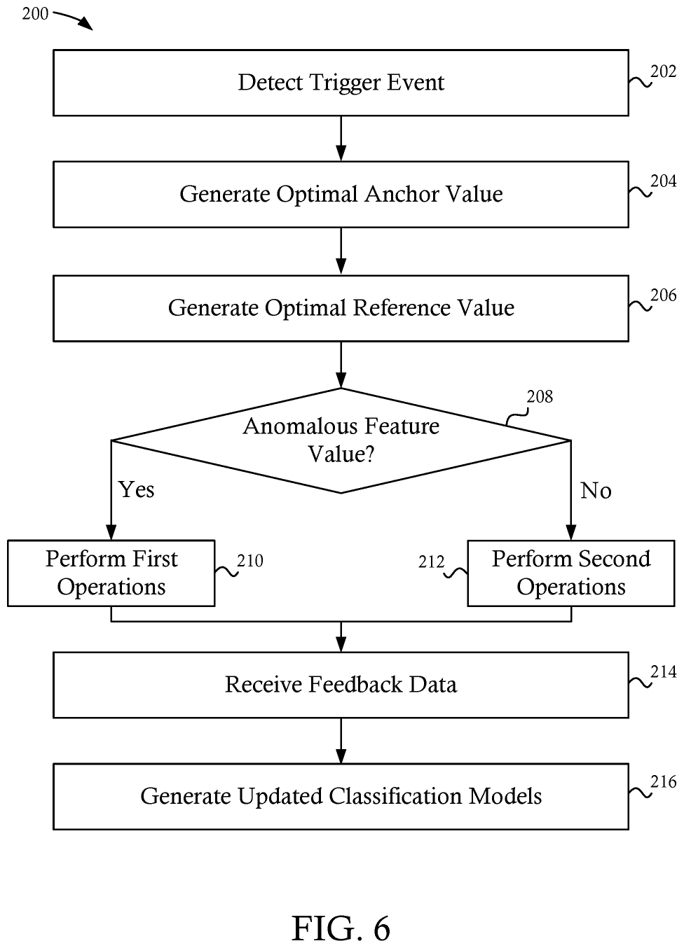

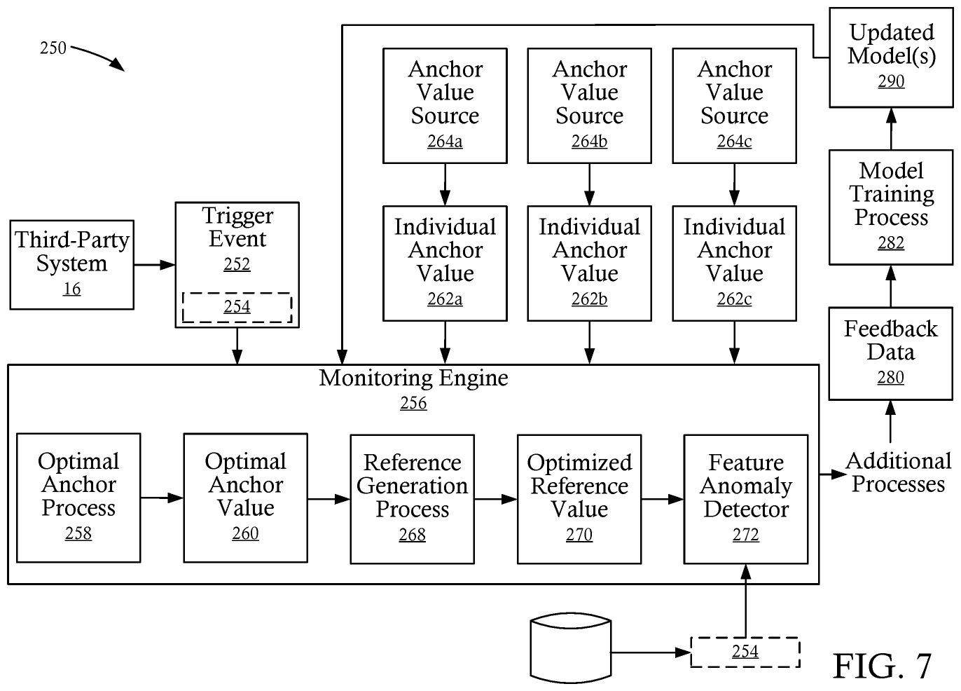

FIG. 6 is a flowchart illustrating an anomaly detection method 200, in accordance with some embodiments. FIG. 7 is a process flow 250 illustrating various steps of the anomaly detection method 200, in accordance with some embodiments. The anomaly detection method 200 provides a scalable anomaly detection framework configurable to detect anomalous values for one or more monitored features within a monitored platform, system, etc., based on a real-time, optimized reference value. Monitored platforms and/or systems may include any suitable system configured to receive data from distributed sources that may include anomalous values. For example, a monitored environment may include a decentralized network environment configured to receive data updates from third-party data sources, such as database modifications implemented and/or requested by third-party systems (e.g., addition of new database records, modification of existing database records, etc.). As another example, a monitored environment may include a sensor environment configured to record outputs of a plurality of sensors configured to monitor and/or estimate a selected phenomenon (e.g., environmental phenomenon). Monitored features may include any suitable feature capable of having a range of values, such as, for example, features capable of having a continuous numeric value. It will be appreciated that the anomaly detection method 200 may be configured to detect anomalous values for any suitable set of features in any suitable electronic environment.

At step 202, a trigger event 252 is detected. Trigger events 252 may include any suitable event, such as a data generation and/or data receipt event, that requires or causes comparison of a reference value to a value of one or more monitored features for one or more data elements. In some embodiments, a trigger event 252 includes a feature value 254. For example, a trigger event such as transmission and/or receipt of a new feature value, update of an existing feature value, transmission and/or receipt of a data structure including a monitored feature value, etc. may include a value for a corresponding feature. In the context of a decentralized network platform, a trigger event 252 may include receipt of a third-party database update (e.g., modification of existing database record or addition of a new database record) that includes a value for one or more monitored features. As another example, in the context of a monitored sensor platform, a trigger event 252 may include generation of a new and/or updated sensor value by one or more sensors. In some embodiments, trigger events 252 including an update or addition of data may be detected by one or more monitoring processes integrated with a data pipeline configured to receive data updates, such as a database update pipeline, a sensor data pipeline, etc.

As another example, in some embodiments, a trigger event 252 includes a change in value for at least one received individual anchor value (e.g., a reference value received from an anchor value source as discussed in greater detail below), such as receipt of an updated individual anchor value, receipt of a new individual anchor value from a new anchor value source, etc. As one example, in the context of a decentralized network platform, a trigger event 252 may include receipt of an individual anchor value update that includes a change in value for an individual anchor value. It will be appreciated that the trigger event 252 may be platform specific, data pipeline specific, and/or related to the type of feature monitored for anomalous values.

In some embodiments, a trigger event 252 may include receipt of a data structure that potentially includes one or more monitored features, e.g., a database update potentially including one or more monitored feature values. In such embodiments, a trigger event 252 may include receipt of a data structure, processing of the data structure, a notification generated by a system in response to the data structure, and/or any other suitable event 252. As another example, in some embodiments, a data structure may be generated including a flag or other indicator that a monitored feature value is included in and/or modified by the data structure and a trigger event 252 may include receipt of a data structure with the appropriate flag. It will be appreciated that any suitable detection scheme may be implemented to identify a trigger event 252.

The trigger event 252 may be detected and/or received by any suitable system, module, engine, etc., such as a monitoring engine 256. The monitoring engine 256 may be actively integrated into a data pipeline, e.g., may receive all data in a data pipeline, and/or may be passively integrated into a data pipeline, e.g., the monitoring engine 256 may review a data pipeline for a trigger event 252 without interrupting the flow of data within the data pipeline. In some embodiments, the monitoring engine 256 may be invoked in response to one or more rules implemented by one or more modules. For example, in some embodiments including a decentralized network platform, a database update system (not shown) may be configured to invoke the monitoring engine 256 when a database update including a change in a monitored feature value is received. Although embodiments are illustrated including a distinct monitoring engine 256, it will be appreciated that the monitoring engine 256 may be integrated into one or more other engines and/or modules, such as, for example, a database modification engine.

At step 204, an optimal anchor value 260 is generated for each monitored feature included in and/or impacted by the trigger event 252. For example, if the trigger event 252 includes a new or updated value for a monitored feature, a single optimal anchor value 260 is generated. As another example, if the trigger event 252 includes a change in value for two or more monitored features, multiple optimal anchor values (not shown) will be generated. In some embodiments, the optimal anchor value 260 represents a reasonable (e.g., average, median, normal, expected, etc.) value for a monitored feature.

In some embodiments, the optimal anchor value 260 is generated by aggregating two or more individual anchor values 262a-262c (collectively “individual anchor values 262”). Each of the individual anchor values 262 provide a reference value for the monitored feature (or an equivalent feature). The individual anchor values 262 may be obtained and/or derived from independent anchor value sources 264a-264c (collectively “anchor value sources 264”). For example, individual anchor values 262 may be obtained from independent sources unrelated to a monitored pipeline, sources associated with current and/or historical operation of the system, platform, etc., and/or any other suitable source. As one non-limiting example, in the context of a decentralized network platform, individual anchor values 262 may be obtained from similarly situated independent platforms, trusted feature value sources, historical feature values, real-time network feature values, etc. As another example, in the context of a sensor system, individual anchor values 262 may be obtained from similar, independent sensors or sensor systems (e.g., sensors not part of the monitored data pipeline), trusted feature value sources, historical feature values, real-time sensor values, etc.

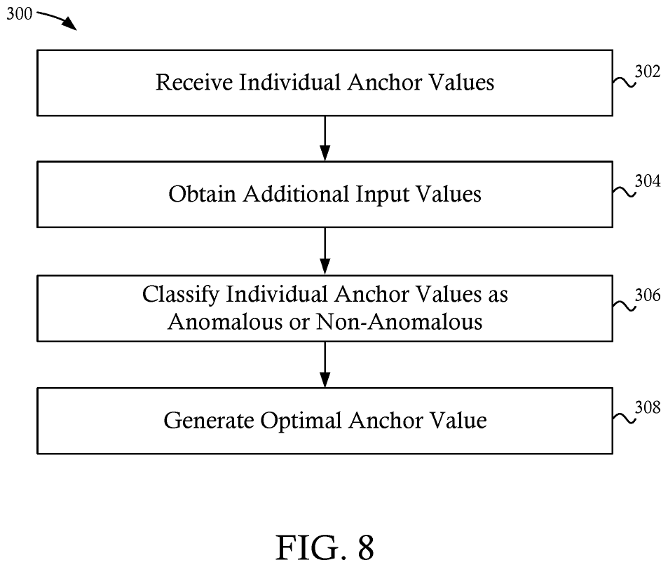

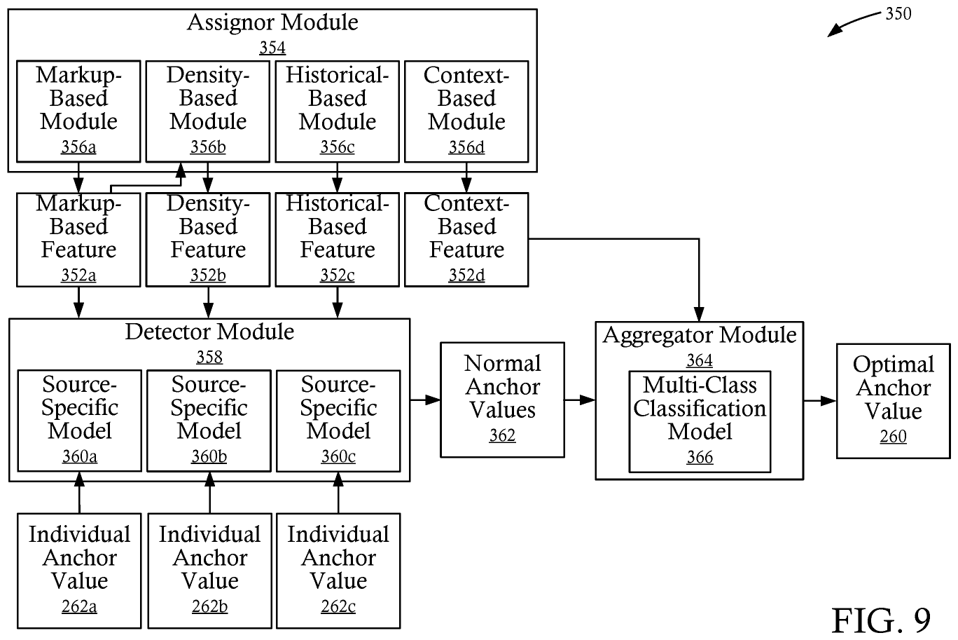

FIG. 8 is a flowchart illustrating an optimal anchor value generation process 300, in accordance with some embodiments. FIG. 9 is a process flow 350 illustrating various steps of the optimal anchor value generation process 300, in accordance with some embodiments. The optimal anchor value generation process 300 may be implemented by any suitable system, module, engine, etc., such as, for example, the monitoring engine 256. At step 302, a plurality of real-time individual anchor values 262 are obtained. Each of the individual anchor values 262 include a reference value for a monitored feature obtained from a source independent of the monitored platform, system, etc.

In some embodiments, each of the individual anchor values 262 includes a reference value obtained in real-time from an anchor value source 264. Anchor value sources 264 may include systems, platforms, etc. that provides data including a feature value for at least one monitored feature. As one non-limiting example, in embodiments including a decentralized network platform, anchor value sources 264 may include, but are not limited to, similar decentralized network platforms that provide similar data and/or services, centralized network platforms that provide similar data and/or services, non-network platforms that provide similar data and/or services, etc. As another non-limiting example, in embodiments including a sensor system configured to obtain a value for an environmental feature (e.g., temperature, humidity, etc.), anchor value sources 264 may include one or more non-sensor sources for the environmental feature value (e.g., weather services, independently reported values, etc.). It will be appreciated that the anchor value sources 264 may be selected based on the monitored feature and/or the system, platform, etc. In some embodiments, a real-time anchor value may be denoted as xᵢ and the set of real-time anchor values may be denoted as A, where xᵢ∈A.

At step 304, one or more additional input features 352a-352d may be obtained. The additional input features may be provided by one or more data sources and/or derived by one or more processes. For example, in some embodiments, additional input features may be generated by an assigner module (or layer) 354 based on received individual anchor values 262 and/or additional data. As another example, in some embodiments, additional input features may be received from additional data sources. Additional input data features may include, but are not limited to, markup-based transformation features, density-based transformation features, historical-based statistical features, context-based statistical features, etc.

In some embodiments, one or more markup-based input features 352a may be generated by a markup-based transformation module 356a. The markup-based transformation module 356a may be configured to apply a transformation to one or more ratio-based features for individual anchor values 262. In some embodiments, ratio-based features provide a relative distance of an individual anchor value from a median feature value associated with a corresponding platform, system, etc. A ratio-based feature may be defined as Rᵢ for a real-time anchor value xᵢ∈A. A ratio-based feature, Rᵢ, may be determined as:

$${R}_{i} = ln \frac{{x}_{i} + c}{{x}_{0} + c} ∀ {x}_{i} ∈ A$$

where x₀ is a median data feature value for feature values observed in the corresponding data pipeline and/or corresponding platform, system, etc.

In some embodiments, the ratio-based features may include unevenly distributed ratios (such as the log-ratio discussed above). For example, an individual anchor value 262a received from a first anchor value source 264a may consistently have a higher value as compared to an individual anchor value 262b received from a second anchor value source 264b. In order to control for variations in anchor value sources, the markup-based transformation module 356a applies a markup-based transformation to normalize received individual anchor values 262. For example, a set of ratio-based features R may be transformed into a set M according to:

$${M}_{i} = \frac{{R}_{i} - {m}_{i}}{{s}_{i}} ∀ i ∈ \{ 1 , … , k \}$$

where mᵢ represents a pre-learned estimate of population means and sᵢ represents a pre-learned estimate of standard deviations for the i^{th} ratio-based feature, e.g., Rᵢ. The markup-based transformation provides a normalized distribution and condenses a feature scale to a smaller scale. In some embodiments, the markup-based transformation module 356a provides one or more model input features, e.g., Mᵢ, that provide a typical, e.g., expected, median, etc., distance for an individual anchor value 262 from an observed data feature within a corresponding platform, system, etc.

In some embodiments, one or more density-based input features 352b may be generated by density estimation module 356b. The density estimation module 356b may be configured to apply a kernel-based density estimation. For example, one or more density-based features 352b may be generated by determining a kernel density estimation of markup-based features, e.g., R or M. In some embodiments, a density-based feature 352b provides a relative distance between received individual anchor values 262. A density-based mapping may be generated from a set of markup-based input features M to a set of density-based input features D such that mapping γᵢ∈D is higher if xᵢ∈M occurs in a close neighborhood of xⱼ∈M for j∈{1, . . . k} and j≠i. In some embodiments, markup-based input features 352a occurring in dense neighborhoods generate a higher density score as compared to sparser markup-based input features 352a. Density-based input features 352b may provide scale-adjusted similarity features between individual anchor values 262 and, in some embodiments, facilitate isolation of anomalous anchor values more efficiently.

In some embodiments, a density-based feature 352b is generated by a kernel density estimation process. A probability density function p (x) is estimated for a specific point x taken from {xₙ} (e.g., the set of individual anchor values) without any knowledge or assumption regarding an underlying distribution. In some embodiments, the probability estimate is determined as:

$$p ( x ) = \frac{1}{k h} {\sum }_{i = 1}^{k} K ( \frac{x - {x}_{i}}{h} )$$

where k represent a number of samples, K denotes a kernel function, and h denotes kernel bandwidth. The hyperparameters K and h may be adjusted (e.g., tuned) to adjust the estimation. In some embodiments, the hyperparameters K and h may be tuned using one or more of cross-validation, incorporation of a classifier's object function, and/or any other suitable process. In some embodiments, the kernel bandwidth h may be selected according to one or more of a rule-of-thumb based approach, a Gaussian kernel based approach, and/or any other suitable selection process.

In some embodiments, one or more of the individual anchor values 262 may not be available for a specific monitored feature and/or a monitored feature associated with a specific data structure. When fewer individual anchor values 262 are available, the density-based input features may have a higher value. For example, where only a single individual anchor value 262a is available, a density-based input feature 352b may include a Gaussian distribution centered at the individual anchor value 262a and having a standard deviation equal to the chosen kernel function. In order to accommodate density-based input features 352b generated from variable numbers of individual anchor values 262, each density-based input feature 352b may be paired with a count of individual anchor values 262 used for generation of the density-based input feature 352b when applied to downstream processing.

In some embodiments, a historical-based input feature 352c may be generated by a historical feature generation module 356c. A historical-based input feature 352c may be generated based on historical anchor values received from the anchor value sources 264 and/or other anchor value sources. For example, a historical-based input feature 352c may include a historical maximum and/or a historical minimum anchor value received from one or more anchor value sources. In some embodiments, a historical-based input feature 352c may include a statistical feature generated from historical anchor values. For example, a historical feature generation module 356c may be configured to apply a statistical generation process to generate one or more statistical features. The statistical generation process may be configured to filter and/or clean anomalous historical values within historical data. For example, the historical feature generation module 356c may apply an unsupervised learning process and/or rule-based logic to generate statistical features, while minimizing and/or eliminating anomalous historical anchor values. In some embodiments, a set of historical-based input features may be denoted as set H.

At step 306, each of the received individual anchor values 262 is classified as one of an anomalous value or a normal (e.g., non-anomalous) value. In some embodiments, a detector module 358 is configured detect classify an individual anchor value 262 as anomalous or non-anomalous. The detector module 356 may include a plurality of source-specific specific classification models 360a-360c, each configured to receive at least one of the individual anchor values 262 and classify the received individual anchor value 262. Each of the source-specific classification models 360a-360c may be configured to receive one or more additional feature inputs, such as, for example, a markup-based input feature 352a, a density-based input feature 352b, a historical-based input feature 352c, etc.

In some embodiments, each of the source-specific classification models 360a-360c are configured (e.g., trained) to detect anomalous values for one or more predetermined anchor value sources 264. For example, the detector module 358 may include source-specific models 360a-360c for each of the individual anchor values 262. As another example, in some embodiments, the detector module 356 may include source-specific models 360a-360c for two or more source types that may be utilized for two or more of the individual anchor values 262 that are generated by the same and/or similar anchor value sources 264. In some embodiments, the source-specific models 360a-360c provide improved coverage and provides for problem isolation as compared to a single classification model trained to classify all received individual anchor values 262.

In some embodiments, the detector module 358 provides a modular platform configured to accommodate new anchor values sources and/or types. For example, when an independent anchor value 262 is received from a new anchor value source 264 (e.g., a previously unused anchor value source), an additional source-specific classification model may be trained and deployed for the added independent anchor value 262 without impacting the existing source-specific classification models 360a-360c. The modular detector module 356 provides a flexible and scalable platform that can easily accommodate new anchor value streams and/or sources without disrupting existing source process flows and/or requiring re-deployment of a detector module 358.

In some embodiments, the source-specific classification models 360a-360c provide an improved (e.g., faster) inference-time operation while satisfying complex optimization objectives to separate anomalous individual anchor values from normal anchor values as compared to existing baseline statistical approaches. In some embodiments, the source-specific classification models 360a-360c include binary classification models trained using a supervised training process. In some embodiments, and as discussed in greater detail below, one or more source-specific classification models 360a-360c may be trained using a source-specific, weak supervision generated labeled data set.

In some embodiments, the detector module 356 is configured to generate a set of normal anchor values 362 including each normal anchor value 362a-362c, e.g., each individual anchor values 262 identified (e.g., classified) as non-anomalous by a corresponding source-specific classification model 360a-360c. The set of normal anchor values 360 may be provided in any suitable format, such as, for example, a set of individual, non-anomalous anchor values, a list of non-anomalous anchor values, an array of non-anomalous anchor values, etc. For example, in some embodiments, the detector module 358 generates an array structure including each individual anchor value in the set of normal anchor values 362 as a value in the array.

At step 308, an optimal anchor value 260 is generated by aggregating two or more of the normal anchor values 362. For example, in some embodiments, an aggregator module 364 is configured to receive the normal anchor values 362 from the detector module 358 and generate an optimal anchor value 260 by aggregating each of the normal anchor values 362. As another example, the aggregator module 364 may be configured to receive the set of normal anchor values 362 and generate an optimal anchor value 260 based on a subset of the set of normal anchor values 362 selected based on an output of each of the source-specific classification models 360a-360c.

In some embodiments, the aggregator module 364 includes a trained multi-class classification model 366 configured to apply a weighted aggregation to the set of normal anchor values 360 to generate the optimal anchor value 260. For example, the trained multi-class classification model 366 may be configured to receive the set of normal anchor values 362 and an additional set of context-based features 356d associated with at least one of the normal anchor values 362 and generate a weighted sum of the normal anchor values 362. The context-based features 356d may be used to by a trained multi-class classification model 366 to determine a corresponding weighting of the normal anchor values 362.

In some embodiments, the trained multi-class classification model 366 includes a multiclass classification model configured to leverage one or more context-based features 352d. For example, in some embodiments, a context-based statistical input feature 352d may be generated by a context generation module 356d of an assigner layer 354. A context-based statistical input feature 352d may be generated based on real-time data feature values received from one or more additional sources, such as other data including a monitored feature value received via a data pipeline and/or stored values associated with the monitored feature. The context generation module 356d may be configured to generate one or more statistical features, such as a minimum, maximum, range, mean, coefficient of variation, etc. based on real-time values of a feature associated with a system, platform, environment, etc., such as, for example, by obtaining real-time feature values from a data store including one or more data structures each having a feature value. In some embodiments, a set of context-based statistical input features may be denoted as O.

In some embodiments, the trained multi-class classification model 366 classifies each normal anchor value 362 into a category having a weight associated therewith. The weights may be determined during iterative training of the trained multi-class classification model 366 and/or by the trained multi-class classification model 366 based on received inputs. For example, in some embodiments, weights for each normal anchor value 362 may be determined based on a distance from a predetermined comparison value, based on one or more context-based statistical input features 352d, and/or based on any other suitable input. In some embodiments, the weights associated with each category include a normalized probability that a given anchor value is equal to and/or closest to a selected comparison value. For example, as discussed in greater detail below, in some embodiments the weights include a normalized probability that a given anchor value is closest to an average feature value derived from operation of an e-commerce platform.

In some embodiments, the optimal anchor value 260 is the normal anchor value 362 that is closest to the weighted combination of the normal anchor values 362. For example, in some embodiments, a weighted median (or average) anchor value is calculated based on the weights assigned to each of the normal anchor values 362 by the trained multi-class classification model 366. The optimal anchor value 260 may be selected as the normal anchor value that is closest (e.g., has the smallest difference as compared to) the weighted median anchor value.

In some embodiments, the output of the aggregator module 364 includes the optimal anchor value 260, the weights applied to each of the normal anchor values 362, and/or data identifying anomalous individual anchor values 262. For example, an output of the aggregator module 364 may include a data structure including the optimal anchor value 260, the set of individual anchor values 262, a weight value associated with each of the individual anchor values 262, and a flag indicating whether the corresponding individual anchor value 262 is anomalous. Although specific embodiments are discussed herein, it will be appreciated that any suitable output may be provided by the aggregator module 364 to one or more additional modules and/or processes.

At step 206, an optimized reference value 270 is generated based on the optimized anchor value 260. In some embodiments, the optimized reference value 270 is generated by applying a predetermined multiplier to the optimal anchor value 260. For example, in embodiments including determination of a maximum optimal reference value 270 (e.g., a maximum value above which a feature value is considered anomalous), the predetermined multiplier may include a value equal to or greater than one, such as 1.5, 2, 3, 4, etc. As another example, in embodiments including determination of a minimum optimized reference value 270 (e.g., a minimum value below which a feature value is considered anomalous), the predetermined multiplier may include a value equal to or less than one, such as, for example. 0.5, 0.25, 0.1, etc. It will be appreciated that the predetermined multiplier value may be any suitable value and may be selected based on any suitable process. The optimized reference value 270 may be generated by any suitable engine, module, process, system, etc., such as a reference generation process 268.

At step 208, the optimized reference value 270 is compared to an obtained feature value 254 to determine when the feature value 254 is anomalous. The optimized reference value 270 provides a threshold between normal (e.g., reasonable, expected, etc.) feature values and anomalous feature values. For example, in some embodiments, the optimized reference value 270 includes a maximum value and a feature value 254 greater than the optimized reference value 270 is identified as an anomalous value. As another example, in some embodiments, the optimized reference value 270 includes a minimum value and a feature value 254 less than the optimized reference value 270 is identified as an anomalous value. In some embodiments, a comparison between the optimized reference value 270 and an obtained feature value 254 may be performed by a feature anomaly detector 270.

In some embodiments, the feature value 254 is obtained from the trigger event 252 for comparison to the optimized reference value 270. For example, where the trigger event 252 includes the feature value 254, the monitoring engine 256 may be configured to obtain the feature value 254 directly from the trigger event (e.g., may extract the feature value 254 from a trigger event 252 including a database update request and/or data structure to be added to a database). When the feature value 254 is obtained from the trigger event 252, the monitoring engine 256 may be configured to perform a single comparison at step 208, e.g., a comparison between the optimal reference value 270 and the feature value 254 obtained from the trigger event 252.

In some embodiments, the feature value 254 may be obtained from one or more data structures stored in a data repository. A feature value 254 may be obtained for each record in a database that corresponds to and/or includes the corresponding feature. For example, in the context of a distributed e-commerce platform, an e-commerce catalog may include multiple database entries representing various third-party listings or offers for the same item (e.g., same product) that each include an entry-specific value for one or more features (e.g., quantity, price, etc.). When a trigger event 252 includes receipt of an updated individual anchor value and/or receipt of a new individual anchor value, the monitoring engine 256 may determine an optimal reference value 270 (as discussed above with respect to steps 204 and 206) and compare the optimal reference 270 to the feature value 254 of each corresponding record in a database.

In some embodiments, when the feature value 254 is identified as an anomalous value, the anomaly detection method 200 proceeds to step 210 and performs a first set of operations in response to the anomalous value. For example, when the trigger event 252 includes a request to add or modify data in an existing repository (e.g., a database update received from a third party, a sensor reading obtained from a system sensor, etc.), the monitoring engine 256 may be configured to reject and/or terminate the trigger event 252 in response to identification of an anomalous feature value (e.g., stop or prevent the database update from being completed, discard the sensor data, etc.). As another example, when the trigger event 252 includes a new or updated individual anchor value and a comparison to an existing record indicates an anomalous feature value, the monitoring engine 256 may remove or flag the existing record in the data repository.

In some embodiments, the one or more operations include generation of a notification indicating that the feature value 254 is anomalous. If additional operations are performed (e.g., rejection of a data update, removal of an existing record from a database, etc.) the notification may identify the operation(s) performed. For example, when the trigger event 252 includes a request to add or modify data in an existing repository (e.g., a database update received from a third party, a sensor reading obtained from a system sensor, etc.), the monitoring engine 256 may generate and transmit a notification to a device that originated the trigger event 252 (e.g., a third-party computing device 16, 18, 20) indicating the feature value in the trigger event 252 was anomalous and that the trigger event 252 was not executed (e.g., a database update was not performed). As another example, in some embodiments, a notification may be generated and transmitted to a review system configured to facilitate review of identified anomalous feature values and/or anomalous anchor values. It will be appreciated that a notification may be transmitted to any suitable system when an anomalous feature value is identified.

In some embodiments, when the feature value 254 is identified as a normal (e.g., non-anomalous) value, the anomaly detection method 200 proceeds to step 212 and performs a second set of operations in response to the normal feature value. when the trigger event 252 includes a request to add or modify data in an existing repository (e.g., a database update received from a third party, a sensor reading obtained from a system sensor, etc.), the monitoring engine 256 may be configured to initiate and/or approve the trigger event 252 in response to identification of a normal feature value (e.g., execute the database update, store the sensor data, etc.). As another example, when the trigger event 252 includes a new or updated individual anchor value and a comparison to an existing record indicates a normal feature value, the monitoring engine 256 may not perform any actions (e.g., the monitoring engine 256 leaves the database record in place).

At optional step 214 feedback 280 may be received in response to one or more operations performed at one of steps 210 or 212. For example, in some embodiments, feedback data 280 indicating that a feature value is not anomalous may be received responsive to a notification transmitted to a review system. As another example, in some embodiments, feedback data 280 indicating that one or more of an optimal anchor value 260, an optimal reference value 270, a normal anchor value, etc. are anomalous may be received from a review system. It will be appreciated that any suitable feedback data 280 related to an optimal reference value 270 and/or feedback data 280 may be received in response to one or more operations performed at one of steps 210 or 212.

At optional step 216, one or more updated classification models 290 may be generated. The updated classification models 290 may be trained and deployed to augment and/or replace one or more existing classification models, such as one or more of the source-specific classification models 360a-360c and/or the trained multi-class classification model 366. In some embodiments, the one or more updated classification models 290 are generated by a training dataset including at least a portion of the feedback data 280.

As one non-limiting example, an anomaly detection method 200 may be configured to detect anomalous values in third-party catalog updates for an e-commerce platform. Third party catalog updates include a request (or attempt) to update and/or add database records representative of items to the e-commerce catalog associated with the e-commerce platform. Each of the updates may be associated with a specific item and include at least one monitored value (e.g., price). In some embodiments, an update pipeline is configured to receive catalog updates from third party systems and a monitoring engine 256 is configured to monitor requested catalog updates to identify anomalous values of one or more numerical features (e.g., a price, quantity, etc.) via a scalable anomaly detection framework.

In some embodiments, when a requested catalog update including a price feature value (e.g., a trigger event 252) is received, a monitoring engine 256 extracts the price (e.g., feature value 254) from the requested catalog update and generates an optimal reference price (e.g., an optimal reference value 270). For example, in some embodiments, the monitoring engine 256 is configured to receive anchor price values (e.g., individual anchor values 262) for the corresponding item of the catalog update from one or more sources including competitor e-commerce websites, a first-party e-commerce website, brick-and-mortar inventory data, etc.

Markup-based features are determined based on received anchor price values. For example, a set M of transformed ratio-based features may be generated to provide a typical distance of a corresponding feature Mᵢ from a median price of the corresponding item in the e-commerce platform (e.g., a distance between a normalized anchor price value and a current median price of the corresponding item within the e-commerce catalog). Density-based features are generated to provide a representation of closeness between the received anchor price values. As discussed above, the density-based features may be derived, at least in part, from the markup-based features.

Historical-based features may be generated based on historical anchor price data, such as historical anchor price values received from the same and/or different anchor price sources. In some embodiments, an unsupervised learning and rules-based process is applied to the historical anchor price data to create statistical features that cleanse (e.g., remove or minimize) anomalous historical anchor price values. Additionally, context-based statistical features may be generated based on real-time prices of corresponding item entries in the e-commerce catalog (e.g., real-time prices for one or more additional listings of an item in an e-commerce catalog).

A detector module applies a plurality of source-specific classification models (e.g., source-specific classification models 358a-358c) to determine if each of the received anchor prices is normal or anomalous. As one example, a source-specific classification model for a competitor-source anchor price may apply a labeling function based on an average unit retail (AUR), an average order-based price in a selected time interval. An AUR may provide a reasonable price comparison, as receiving orders through an e-commerce platform at a given price (e.g. AUR) demonstrates that the price value is reasonable. The source-specific classification model for a competitor-source anchor price may be configured to label a competitor anchor price as reasonable when the competitor anchor price is within a predetermined threshold of the AUR and otherwise label the competitor anchor price as anomalous.

As another example, a source-specific classification model be generated by an iterative process including an anchor masking process. For example, items having dense anchor coverage may be biased by a population of production price events. An anchor masking process may be applied to provide consistent distribution of a training set for a subset of data (e.g., anchor prices). Anchor masking applies random nullification of anchor prices to provide an equivalent level of anchor sparsity in a training dataset as compared to a production environment. A set of distance-based input features may be determined using masked anchor sets and/or classification models generated using anchor masking. Although specific embodiments are discussed herein, it will be appreciated that any suitable labeling process based on any suitable label criteria may be applied by a source-specific classification model.

A set of non-anomalous (e.g., normal) anchor prices are provided to an aggregation module configured to aggregate the non-anomalous anchor prices to generate an optimal anchor price. As discussed above, an aggregation module may apply a trained multi-class classification model to generate a weighted mean output, e.g., a weighted mean anchor price. In some embodiments, a trained multi-class classification model is configured to apply weights such that a weighted mean anchor price is an anchor price being closes to a target value, such as an AUR. In some embodiments, a trained multi-class classification model is configured to apply weights to generate an aggregated anchor price from each received non-anomalous anchor price.

An optimal price ceiling (e.g., optimal reference value 270) is generated by multiplying the generated optimal anchor price by a predetermined multiplier. The optimal price ceiling is compared to the price extracted from the received catalog update request. If the price value of the catalog update request is less than the optimal price ceiling, the price value is considered normal and the catalog update request is processed (e.g., the item offer is added to the e-commerce catalog). If the price value of the catalog update request s greater than the optimal price ceiling, the price value is considered anomalous and the catalog update request is rejected. A notification may be provided to the third-party that generated the catalog update request and/or a review system, as discussed above.

The disclosed systems and methods utilize an ensemble of trained models (e.g., trained classification models) to detect irregularities in one or more features. The trained models are configured to filter anomalous anchor values and generate an optimal anchor value based on an optimized weighting scheme. The generated optimal anchor value provides a reliable, real-time reference value for the one or more features. In some embodiments, the source-specific classification models provide a modular system capable of adding (e.g., ingesting) additional anchor value sources when available. In some embodiments, the trained weighted classification model provides an interpretable solution that weights more reliable anchor value sources higher vs less reliably anchor value sources. A trained multiclass classification model (e.g., trained multi-class classification model) predicts which sources tend to be more reliable. The disclosed systems and methods provide a resource and timing improvement over existing systems, producing anomaly detection results and/or predictions using a lightweight, fast, expandable architecture, as described herein.

It will be appreciated that anomaly detection processes as disclosed herein, particularly on large datasets intended to be used with large network platforms such as third-party e-commerce platforms, is only possible with the aid of computer-assisted machine-learning algorithms and techniques, such as the use of ensemble classification models. In some embodiments, machine learning processes including trained classification models are used to perform operations that cannot practically be performed by a human, either mentally or with assistance, such as classification of anchor values as normal or anomalous based on received and generated model features, weighting of anchor values based on received and generated model features, and real-time detection of anomalous feature values based on generated real-time optimal reference values. It will be appreciated that a variety of machine learning techniques can be used alone or in combination to generate trained classification models.

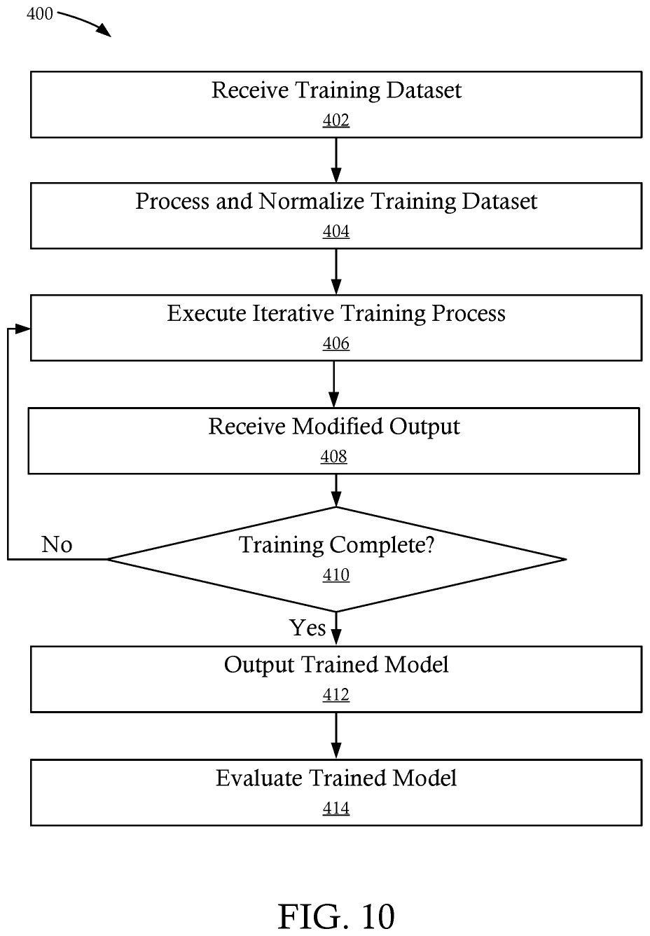

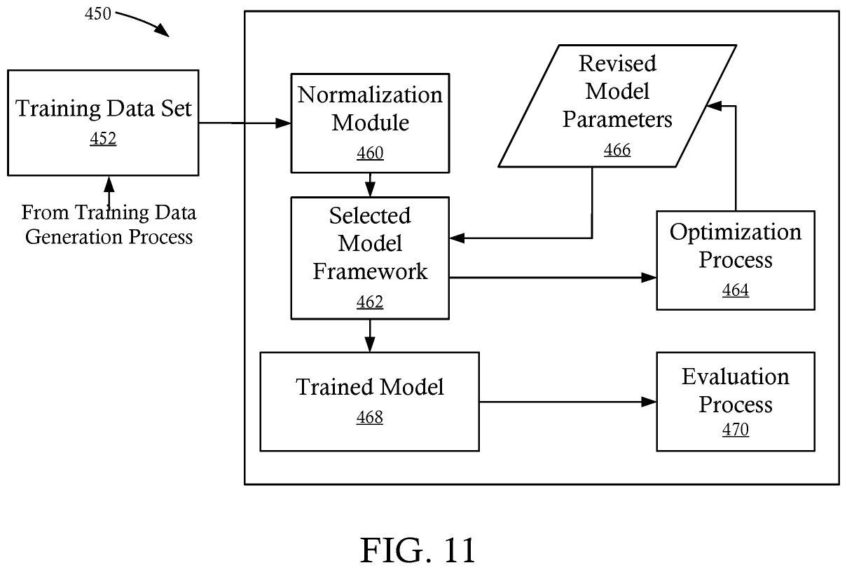

In some embodiments, a trained classification model can include and/or implement one or more trained models, such as a trained tree-based model. In some embodiments, one or more trained models can be generated using an iterative training process based on a training dataset. FIG. 10 illustrates a method 400 for generating a trained model, such as a trained optimization model, in accordance with some embodiments. FIG. 11 is a process flow 450 illustrating various steps of the method 400 of generating a trained model, in accordance with some embodiments. At step 402, a training dataset 452 is received by a system, such as a processing device 10. The training dataset 452 can include labeled and/or unlabeled data. For example, in some embodiments, the training dataset 452 includes a weakly labeled dataset.

In some embodiments, a weakly labeled dataset (e.g., semi-supervised dataset) may be generated by a weak supervision process configured to leverage labeling functions to encode domain heuristics to build noisy labels and subsequentially denoise them. In some embodiments, a set of similar, but distinct, labeling functions may be applied for generating source-specific datasets configured to generate source-specific classification models, such as source-specific classification models 360a-360c. In some embodiments, a weak labeling process may be configured to apply one or more heuristic labeling rules to apply one or more tags to data elements to generate a training dataset 452.

At optional step 404, a received and/or generated training dataset 452 is processed and/or normalized by a normalization module 460. For example, in some embodiments, the training dataset 452 can be augmented by imputing or estimating missing values of one or more features associated with source-specific anchor values. In some embodiments, processing of the received training dataset 452 includes outlier detection configured to remove data likely to skew training of a source-specific. In some embodiments, processing of the received training dataset 452 includes removing features that have limited value with respect to training of a source-specific classification model, a trained multi-class classification model, etc.

In some embodiments, a masking process may be applied to a training dataset 452 to simulate a production-like availability distribution. For example, a training dataset 452 may include a dense set of anchor values and a production distribution may include only a sparse (e.g., limited) set of anchor values. Anchor masking may be applied to randomly mask (e.g., eliminate or ignore) a certain number of data points to mimic a production-like availability distribution of anchor values.

At step 406, an iterative training process is executed to train a selected model framework 462. The selected model framework 462 can include an untrained (e.g., base) machine learning model, such as a tree-based framework (e.g., random forest, decision tree, etc.) and/or a partially or previously trained model (e.g., a prior version of a trained model). The training process is configured to iteratively adjust parameters (e.g., hyperparameters) of the selected model framework 462 to minimize a cost value (e.g., an output of a cost function) for the selected model framework 462. In some embodiments, the cost value is related to a tree-based model.

The training process is an iterative process that generates set of revised model parameters 466 during each iteration. The set of revised model parameters 466 can be generated by applying an optimization process 464 to the cost function of the selected model framework 462. The optimization process 464 can be configured to reduce the cost value (e.g., reduce the output of the cost function) at each step by adjusting one or more parameters during each iteration of the training process.

After each iteration of the training process, at step 408, a determination is made whether the training process is complete. The determination at step 408 can be based on any suitable parameters. For example, in some embodiments, a training process can complete after a predetermined number of iterations. As another example, in some embodiments, a training process can complete when it is determined that the cost function of the selected model framework 462 has reached a minimum, such as a local minimum and/or a global minimum.

At step 410, a trained model 468, such as a trained source-specific classification models and/or trained multi-class classification models, is output and provided for use in n anomaly detection method, such as the anomaly detection 200 discussed above with respect to FIGS. 6-7. At optional step 412, a trained model 468 can be evaluated by an evaluation process 470. A trained model can be evaluated based on any suitable metrics, such as, for example, an F or F1 score, normalized discounted cumulative gain (NDCG) of the model, mean reciprocal rank (MRR), mean average precision (MAP) score of the model, median of absolute percentage difference, absolute percentage error, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory;
a processor communicatively coupled to the non-transitory memory, wherein the processor is configured to read a set of instructions to:
receive a plurality of source-specific anchor values;
generate a plurality of model features;
implement a plurality of trained source-specific classification models each associated with at least one of the plurality of source-specific anchor values and each configured to receive a subset of the plurality of model features, wherein each of the plurality of trained source-specific classification models is configured to classify the associated at least one of the plurality of source-specific anchor values as one of anomalous or non-anomalous;
implement a trained weighted classification model to generate an optimal anchor value, wherein the optimal anchor value includes a weighted aggregation of each of the plurality of source-specific anchor values identified as non-anomalous; and
generate an optimal reference value based on the optimal anchor value.

2. The system of claim 1, wherein the plurality of model features comprise at least one of a markup-based transformation feature, a density-based transformation feature, a historical-based statistical feature, or a combination thereof.

3. The system of claim 2, wherein the markup-based transformation feature comprises one or more ratio-based features transformed to include a similar distribution.

4. The system of claim 2, wherein the density-based transformation feature includes a kernel density estimation.

5. The system of claim 2, wherein the historical-based statistical features are generated by an unsupervised learning and rule-based process.

6. The system of claim 1, wherein at least one of the plurality of trained source-specific classification models is generated by an iterative training process based on a weakly-labeled training dataset.

7. The system of claim 1, wherein the plurality of model features includes context-based statistical features, and wherein the trained weighted classification model is configured to receive the context-based statistical features as an input.

8. The system of claim 1, wherein the optimal reference value is generated by applying a multiplier to the optimal anchor value.

9. The system of claim 1, wherein the processor is further configured to:
compare the optimal reference value to a received feature value;
label the received feature value as anomalous or non-anomalous based on the comparison; and
in response to labeling the feature value as anomalous, generate a notification.

10. A computer-implemented method, comprising:
receiving a plurality of source-specific anchor values;
generating a plurality of model features;
implementing a plurality of trained source-specific classification models each associated with at least one of the plurality of source-specific anchor values and each configured to receive a subset of the plurality of model features, wherein each of the plurality of trained source-specific classification models is configured to classify the associated at least one of the plurality of source-specific anchor values as one of anomalous or non-anomalous;
implementing a trained weighted classification model to generate an optimal anchor value, wherein the optimal anchor value includes a weighted aggregation of each of the plurality of source-specific anchor values identified as non-anomalous; and
generating an optimal reference value based on the optimal anchor value.

11. The computer-implemented method of claim 10, wherein the plurality of model features comprise at least one of a markup-based transformation feature, a density-based transformation feature, a historical-based statistical feature, or a combination thereof.

12. The computer-implemented method of claim 11, wherein the markup-based transformation feature comprises one or more ratio-based features transformed to include a similar distribution.

13. The computer-implemented method of claim 11, wherein the density-based transformation feature includes a kernel density estimation.

14. The computer-implemented method of claim 11, wherein the historical-based statistical features are generated by an unsupervised learning and rule-based process.

15. The computer-implemented method of claim 10, wherein at least one of the plurality of trained source-specific classification models is generated by an iterative training process based on a weakly-labeled training dataset.

16. The computer-implemented method of claim 10, wherein the plurality of model features includes context-based statistical features, and wherein the trained weighted classification model is configured to receive the context-based statistical features as an input.

17. The computer-implemented method of claim 10, wherein the optimal reference value is generated by applying a multiplier to the optimal anchor value.

18. The computer-implemented method of claim 10, comprising:
comparing the optimal reference value to a received feature value;
labeling the received feature value as anomalous or non-anomalous based on the comparison; and
in response to labeling the feature value as anomalous, generating a notification.

19. A non-transitory computer readable medium having instructions stored thereon, wherein the instructions, when executed by at least one processor, cause at least one device to perform operations comprising:
receiving a feature value;
receiving a plurality of source-specific anchor values;
generating a plurality of model features;
implementing a plurality of trained source-specific classification models each associated with at least one of the plurality of source-specific anchor values and each configured to receive a subset of the plurality of model features, wherein each of the plurality of trained source-specific classification models is configured to classify the associated at least one of the plurality of source-specific anchor values as one of anomalous or non-anomalous;
implementing a trained weighted classification model to generate an optimal anchor value, wherein the optimal anchor value includes a weighted aggregation of each of the plurality of source-specific anchor values identified as non-anomalous;
generating an optimal reference value based on the optimal anchor value;
comparing the optimal reference value to a received feature value;
labeling the received feature value as anomalous or non-anomalous based on the comparison; and
in response to labeling the feature value as anomalous, generating a notification.

20. The non-transitory computer readable medium of claim 19, wherein the plurality of model features comprise at least one of a markup-based transformation feature, a density-based transformation feature, a historical-based statistical feature, or a combination thereof.
